(19) United States
(12) Patent Application Publication
(10) Pub. No.: US 2010/0246371 A1
(43) Pub. Date: Sep. 30, 2010

(54) OPTICAL INFORMATION RECORDING APPARATUS AND METHOD OF OPTICALLY RECORDING INFORMATION

(75) Inventors: Masahiro Kanamaru, Kanagawa-ken (JP); Kazuki Matsumoto, Kanagawa-ken (JP); Rumiko Hayase, Kanagawa-ken (JP); Yoshiaki Kawamonzen, Tokyo (JP); Norikatsu Sasao, Tokyo (JP); Masaya Terai, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/719,567

(22) Filed: Mar. 8, 2010

(30) Foreign Application Priority Data
Mar. 24, 2009 (JP) P2009-072713

(51) Int. Cl. G11B 7/135

(52) U.S. Cl. 369/112.27; G9B/7.112

(57) ABSTRACT

According to a first aspect of the invention, an optical information recording apparatus includes a spatial beam modulator, an optical component, a drive unit, and a control unit. The apparatus performs angle-multiplex recording of the information so that an absolute value of a bisector angle θₓ for n-th recording (1≦n≦rN) is smaller than an absolute value of a bisector angle θₓ for m-th recording (m>n and rN<m≦N). Here, N is the number of pages to be defined as the total number of recording times performed on a recording spot of an optical information recording medium. The n-th recording is performed on the recording spot with the reference beam and the information beam. r is a rate to be determined by a volumetric shrinkage of the optical information recording medium. The volumetric shrinkage increases with irradiating the optical information recording medium with the reference beam and the information beam.

### CROSS REFERENCE TO RELATED APPLICATION

This application is based upon and claims the benefit of priority from the prior Japanese Patent Application No. 2009-072713, filed on Mar. 24, 2009, the entire contents of which are incorporated herein by reference.

### FIELD OF THE INVENTION

The present invention relates to an optical information recording apparatus and a method of optically recording information as a hologram.

### DESCRIPTION OF THE BACKGROUND

An optical information recorder is known as an information recording apparatus capable of recording large-capacity data such as a high-density image. A magneto-optical information recorder or apparatus such as an optical phase-change information recorder and CD-R are practically used as the optical information recorder.

Requirements increase more and more with respect to high capacity of information recorded on an optical recording medium. In order to realize the foregoing high-capacity optical information recording, holography, in particular, a hologram-type optical information recording/reproducing apparatus using digital volume holography is described (JP-A 2006-3387 (Kokai)).

An optical recording/reproducing apparatus using holography has a recording mode and a reproducing mode. In the recording mode, the apparatus makes interference between an information beam having two-dimensional information data and a reference beam inside an optical information recording medium to record the information as an interference fringe. In the reproducing mode, the apparatus applies only the reference beam to the interference fringe recorded. The optical information recording/reproducing apparatus has merits capable of inputting and outputting high-capacity optical information rapidly.

There exist several methods for increasing the storage density of an optical information recording medium. One of the methods is a multiplex recording mode. This multiplex recording mode records one or more page-data on the same spot of the optical information recording medium. Examples of the multiplex recording proposed include angle-multiplex recording with shifting the incident angle of a laser beam, shift multiplex recording with shifting a beam position slightly, and wavelength-multiple recording with shifting the wavelength of a laser beam.

In the angle-multiplex recording or the shift multiplex recording, changing a relative position or angle of the laser beam to the optical information recording medium enables the multiplex recording. The angle-multiplex recording system is a novel one that has been never employed in conventional CD and DVD recorders, and is essential to a dual beam interference system which records an interference fringe generated between an information beam and a reference beam on a recording layer.

There is known a material for the optical information recording medium. The material contains a radical polymerizable monomer, thermoplastic binder resin, a photo-radical polymerization initiator, a sensitizing dye, etc. as main components. The above-mentioned photosensitive composition for holographic recording is formed into a film-shape to be a recording layer onto which information is recorded with an interference exposure.

When the recording layer has been subjected to the interference exposure, the regions of the recording layer which have been strongly irradiated with light are allowed to undergo the polymerization reaction of the radical polymerizable monomer. The radical polymerizable monomer diffuses from the regions where the intensity of exposure beam is weak to the regions where the intensity of exposure beam is strong, thereby generating a gradient of concentration thereof in the recording layer. That is, depending on the intensity of the interference beam, a difference in the concentration of the radical polymerizable monomer takes place, thereby generating a difference in refractive index in the recording layer. A Japanese laid-open patent application JP-A 2006-3387 (Kokai) discloses a recording medium including a three-dimensional cross-linking polymer matrix with polymerizable monomers dispersed therein.

The recording layer sometimes locally shrinks as a result of the polymerization of the radical polymerizable monomer. In the angle-multiplex recording, the volumetric shrinkage of the recording medium causes a change in the angle of interference fringes generated in the optical information recording medium. For this reason, it may become impossible to accurately reproduce the data that have been recorded therein because the incident angles of the reference beam differ at the time of recording and reproducing.

### SUMMARY OF THE INVENTION

According to a first aspect of the invention, an optical information recording apparatus includes a spatial beam modulator, an optical component, a drive unit, and a control unit. The spatial beam modulator converts a light beam emitted from a light source into an information beam carrying information. The optical component focuses the information beam on an optical information recording medium in order to irradiate the optical information recording medium with a reference beam and the information beam so that the reference beam and the information beam intersect with each other on the optical information recording medium. The optical information recording medium includes an information recording layer capable of recording information as a hologram with an interference fringe generated by interference between the information beam and the reference beam. The drive unit rotates the optical information recording medium or the optical component. The control unit performs angle-multiplex recording of the information on the optical information recording medium by controlling the light source to emit the beam while driving the optical information recording medium or the optical component so that an absolute value of a bisector angle θₓ for n-th recording (1≦n≦rN) is smaller than an absolute value of a bisector angle θₓ for m-th recording (m>n and rN<m≦N). The bisector angle is defined as an angle between a bisector and a vertical line. The bisector is defined as a bisector of an angle θ_{RS} between the information beam and the reference beam. The vertical line is defined as a vertical line of the optical information recording medium. Here, N is the number of pages to be defined as the total number of recording times performed on a recording spot of the optical information recording medium. The n-th recording is performed on the recording spot with the reference beam and the information beam. r is a rate to be determined by a volumetric shrinkage of the optical information recording medium. The volumetric shrinkage increases with irradiating the optical information recording medium with the reference beam and the information beam.

According to a second aspect of the invention, a method of optically recording information includes the following steps:

converting a beam emitted from a light source into an information beam carrying information by using a spatial beam modulator;
focusing the information beam on an optical information recording medium in order to irradiate the optical information recording medium with a reference beam and the information beam so that the reference beam and the information beam intersect with each other on the optical information recording medium by using an optical component;
rotating the optical information recording medium or the optical component by using a drive unit; and
controlling the light source to emit the light beam while driving the optical information recording medium or the optical component by using a control unit to perform angle-multiplex recording of the information on the optical information recording medium so that an absolute value of a bisector angle for n-th recording (1≦n≦rN) is smaller than an absolute value of a bisector angle for m-th recording (m>n and rN<m≦N). Here, the bisector angle is defined as an angle between a bisector and a vertical line. The bisector is defined as a bisector of an angle between the information beam and the reference beam. The vertical line is defined as a vertical line of the optical information recording medium. N is the number of pages to be defined as the total number of recording times performed on a recording spot of the optical information recording medium. The n-th recording is performed on the recording spot with the reference beam and the information beam. r is a rate to be determined by a volumetric shrinkage of the optical information recording medium. The volumetric shrinkage increases with irradiating the optical information recording medium with the reference beam and the information beam.

### BRIEF DESCRIPTION OF DRAWINGS

The accompanying drawings, which are incorporated in and constitute a part of this specification, illustrate embodiments of the invention and together with the description, serve to explain the principles of the invention.

FIG. 1 is a view showing main components of an optical information recording/reproducing apparatus 100 according to a first embodiment.

FIG. 2 is a view showing a relationship among an information beam, a reference beam, an optical information recording medium.

FIG. 3 is a view showing main components of the optical information recording/reproducing apparatus 100 according to the first embodiment.

FIG. 4 is a view showing a recordable range of an incident angle (θ_{R}) of the reference beam.

FIG. 5 is a schematic view showing the volumetric shrinkage of the optical information recording medium.

FIG. 6 is a graph showing a relationship between the incident angle of the reference beam and the displacement angle generated at each incident angle thereof.

FIG. 7 is a graph showing a diffraction efficiency of beams with which the recording medium 22 was irradiated at each recording angle.

FIG. 8 is a graph showing a relationship between a M/# and light energy given to the optical information recording medium.

FIG. 9 is a graph showing a relationship between a recording angle (θₓ) and the displacement angle.

FIG. 10 is a graph showing the volumetric shrinkage due to recording of information on the recording medium.

FIG. 11 is a view showing a first angle range and two second angle ranges.

FIG. 12 is a flow chart showing processing of the information recording with the optical information recording/reproducing apparatus according to the first embodiment.

FIG. 13 is a view showing main components of the optical information recording/reproducing apparatus according to a second embodiment.

### DETAILED DESCRIPTION OF THE EMBODIMENTS

Embodiments of an optical information recording/reproducing apparatus and a method of optically recording information according to the present invention are described below with reference to drawings.

### First Embodiment

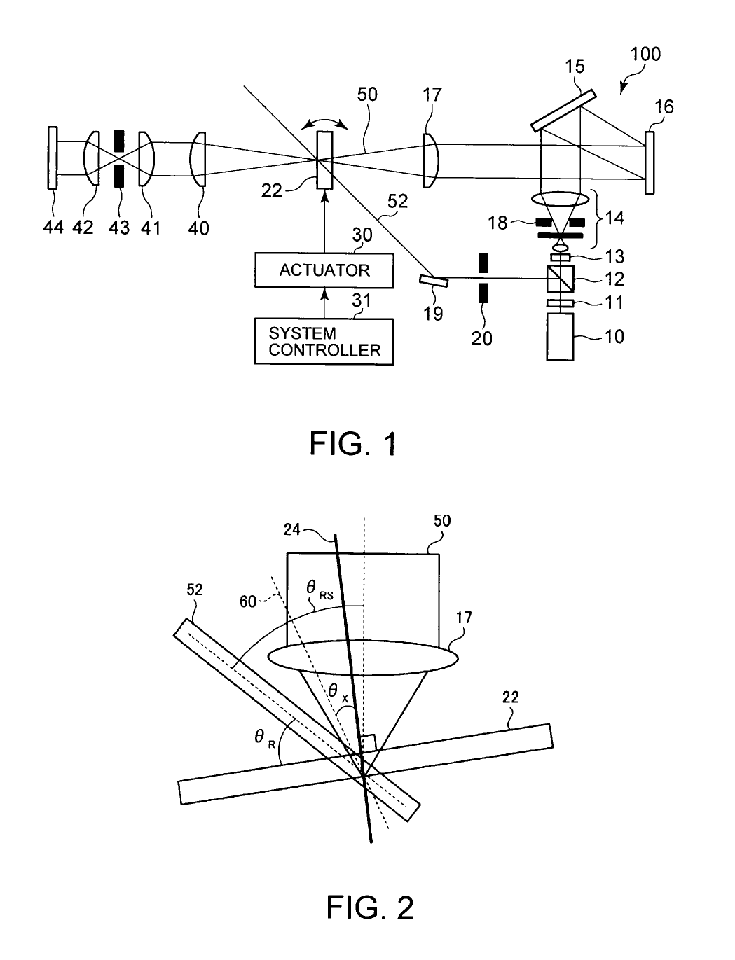

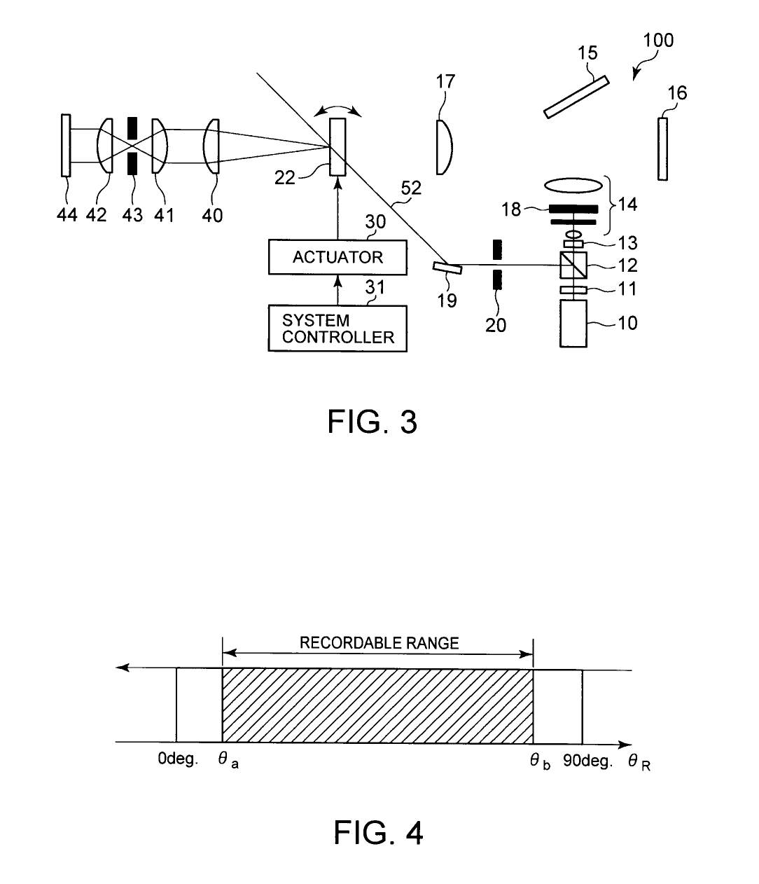

FIG. 1 is a view showing main components of an optical information recording/reproducing apparatus 100 according to a first embodiment. The optical information recording/reproducing apparatus is capable of optically recording and optically reproducing. The apparatus may be an optical information recording apparatus or may be an optical information reproducing apparatus. The operation thereof for recording information is described below with reference to FIG. 1. The optical information recording/reproduction apparatus 100 employs an angle-multiplex recording mode to record/reproduce information. A light source 10 emits a light beam, more specifically a parallel pencil. A light beam is referred to as a “beam” hereinafter. A laser light source for emitting coherent light is preferably employed for the light source 10. The parallel pencil emitted from the light source 10 enters PBS (polarized beam splitter) 12, and is divided into two beams. An s-polarized beam is reflected to be a reference beam, and a p-polarized beam passes through PBS 12 to be an information beam. A half-wavelength plate 11 is disposed between the light source 10 and PBS 12. The half-wavelength plate 11 controls the intensity ratio of the two beams.

A wavelength plate 13 rotates the polarized-beam which passes through PBS 12, i.e., the p-polarized beam. The polarized-beam is expanded by a beam expander 14, and is then formed into a parallel pencil. The formed beam is reflected by a reflection mirror 15 (optical component) to enter a spatial beam modulator 16. The spatial beam modulator 16 displays information as a two-dimensional pattern. The formed beam is amplitude-modulated by the spatial beam modulator 16 displaying a two-dimensional information pattern to be an information beam 50. The information beam 50 passes through a lens 17 (optical component), and is directed with a beam waist to an optical information recording medium 22 (referred to as the “recording medium” 22 hereinafter). A shutter 18 is disposed among the lenses of a beam expander 14. Another beam reflected by PBS 12 is further reflected by a mirror 19 (optical component) to be a reference beam 52, thereby allowing the reference beam 52 to be incident on the recording medium 22. A shutter 20 is disposed between PBS 12 and the mirror 19.

The recording medium 22 includes a recording layer capable of recording information as a hologram. The information beam 50 and the reference beam 52 are directed onto the recording medium 22 so that the two beams 50 and 52 intersect with each other at the recording layer of the recording medium 22. That is, the information beam 50 and the reference beam 52 are incident onto the same spot in the recording medium 22. At this time, within the recording medium 22, the information beam 50 and the reference beam 52 interfere with each other, thereby generating an interference fringe representing an information pattern displayed on the spatial beam modulator 16. The interference fringe is a pattern which reflects recording conditions such as an incident angle, a wave front, a wavelength, etc. of the information beam 50 and the reference beam 52. The interference fringe is recorded on the recording layer of the recording medium 22 as a refractive-index change.

A system controller 31 (control unit) controls an actuator 30 (drive unit) to rotate the recording medium 22 by each predetermined angle. The information beam 50 and the reference beam 52 are set up so that the same spot of the recording medium 22 is irradiated with the information and reference beams 50, 52 during the rotating of the recording medium 22. In addition, the medium is rotated about a rotation axis perpendicular to the plane of the drawing (FIG. 2). The rotation axis passes through the point at the intersection of the information beam 50 with the reference beam 52.

FIG. 2 is a view showing a positional relationship among the information beam 50, the reference beam 52, and the recording medium 22. As shown in FIG. 2, an angle between the reference beam 52 and the recording medium 22 will be referred to as an incident angle (θ_{R}) of the reference beam 52 below. An angle between the information beam 50 and the reference beam 52 will be referred to as an intersection angle (θ_{RS}) below. A bisector 60 of the intersection angle (θ_{RS}) is further defined. Then, an angle between the bisector 60 and a vertical line of the recording medium will be referred to as a bisector angle (θₓ). When the recording medium 22 is rotated as mentioned above, the incident angle (θ_{R}) of the reference beam 52 changes. In addition, although the bisector angle (θₓ) changes at this time, the intersection angle (θ_{RS}) does not change. The bisector angle (θₓ) and the intersection angle (θ_{RS}) will be further mentioned later.

At the time of recording information, the system controller 31 controls the actuator 30 to rotate the recording medium 22 so that the incident angle (θ_{R}) of the reference beam 52 is set at a prescribed angle. A predetermined information pattern is displayed on the spatial beam modulator 16 to be recorded on the recording medium 22 with the incident angle (θ_{R}) of the reference beam 52 set at the prescribed angle. Then, the incident angle (θ_{R}) of the reference beam 52 is shifted by a predetermined angle to change the information pattern displayed on the spatial beam modulator 16. The information pattern is recorded on the recording medium 22 in the same way. The same spot exposed to the information beam 50 on the recording medium 22 is exposed also to the reference beam 52 while shifting the incident angle (θ_{R}) of the reference beam 52, thereby recording different information patterns twice or more times.

The recording medium 22 is provided with angle selectivity, thereby allowing it to reproduce information separately depending on the incident angle (θ_{R}) of the reference beam. Therefore, multiple pieces of information can be recorded/reproduced on/from the same recording spot inside the recording medium 22. Two-dimensional information recorded at an incident angle (θ) is referred to as a “page”, and a set of pages is referred to as a “book”. The operation at the time of recording information will be explained in detail later.

At the time of reproducing information, the shutter 18 is closed to shut off the information beam 50. Thereby, the recording medium 22 is irradiated with only the reference beam 52. When the incident angle (θ_{R}) of the reference beam 22, i.e., the angle of the recording medium 22 is set to an appropriate angle with controlling the actuator 30, diffraction of the reference beam 52 takes place according to the interference fringe recorded at the appropriate angle. Then, the diffracted beam is formed as an image on the surface of an image sensor 44, thereby reproducing information. The pieces of information recorded with the angle-multiplex recording are reproduced separately by selecting the angle of the recording medium 22. As mentioned above, changing the incident angle (θ_{R}) of the reference beam 52 allows it to record information on different pages, and to read out from different pages.

As shown in FIG. 1, a lens 40, relay lenses 41 and 42 are disposed between the recording medium 22 and the image sensor 44. An aperture 43 is disposed at a beam waist between the relay lenses 41 and 42. The narrower the aperture 43 is, the higher the recording density of book is. However, on the other hand, a signal-to-noise ratio (SNR) decreases with narrowing the aperture 43. For this reason, the diameter of the aperture 43 is set to be 0.5 mm to 2.0 mm. The diameter of the aperture 43 can be set to be a suitable value depending on the spatial beam modulator 16 or the lenses employed.

FIG. 4 is a view showing a recordable range for the incident angle (θ_{R}) of the reference beam 52. The recordable range means a range of the incident angle (θ_{R}) of the reference beam 52 which can be set up at the time of recording information. The recordable range does not include a range of 0° to 90°, but a limited range θₐ≦θ_{R}≦θ_{b} (0°<θₐ<90°, θₐ<θ_{b}<90°). The range θₐ≦θ_{R}≦θ_{b} is referred to as [θₐ, θ_{b}]. The range θₐ≦θ_{R}≦θ_{b} is narrower than the range of 0°<θ<90°. This is because the lens 17 is disposed close to the recording medium 22. The value of θₐ is limited by NA (Numerical Aperture) of the lens 17. For example, θₐ is the smallest value, i.e., θₐ=40° at NA=0.65. When θ_{b} is about 65° or more, a reflection increases rapidly from the surface of the recording medium 22. Therefore, when θ_{b} is about 65° or more, a sufficient exposure cannot be performed. Then, θ_{b}=65° is required.

Moreover, the angle selectivity for a signal beam (including information data) reproduced from the recording medium 22 is given by (formula 1).

$$η ( {θ}_{RS} , L , Δ {θ}_{RS} ) = {( \frac{π nL}{λ cos ( {θ}_{RS} )} )}^{2} sin {c ( \frac{2 nL sin ( {θ}_{RS} / 2 )}{λ} Δ {θ}_{RS} )}^{2} \qquad ( formula 1 )$$

Here, η expresses a diffraction efficiency.
L, λ, n, and θ_{RS} express the followings:
L expresses the thickness of the recording medium 22;
λ expresses the wavelength of the light beam emitted from the light source 10;
n expresses the refractive index of the recording medium 22; and
θ_{RS} expresses the angle between the information beam 50 and the reference beam 52.

(Formula 1) is called a “sinc function” characteristically having periodic side peaks.

As shown in (formula 1), the larger the intersection angle (θ_{RS}) is, the more the angle selectivity for holograms recorded is, provided that the wavelength of the beam emitted from the light source 10 and the thickness of the recording medium 22 are fixed. That is, the larger the intersection angle (θ_{RS}) is, the higher the density of recording is. However, on the other hand, if the intersection angle (θ_{RS}) becomes large, θ_{b} will become small, thereby reducing the number of pages on which information is recorded. When the above-mentioned trade-off of the intersection angle (θ_{RS}) is taken into consideration, the intersection angle (θ_{RS}) is preferably set to be around 50°. As mentioned above, in the present embodiment, it is preferable that θₐ=40°, θ_{b}=65° and the intersection angle θ_{RS}=50°.

The optical information recording/reproducing apparatus 100 according to the first embodiment records two or more pieces of information while changing the incident angle θ_{R} of the reference beam 52 by a prescribed increment of angle in the recordable range [θₐ, θ_{b}]. The changing of the incident angle θ_{R} of the reference beam 52 is carried out by the actuator 30 rotating the recording medium 22 according to the instruction of the system controller 31. However, information is recorded in a first angle range [θᵢ, θⱼ] (θₐ<θᵢ<θⱼ<θ_{b}) which is a part of the recordable range [θₐ, θ_{b}] earlier than in the other parts of the recordable range [θₐ, θ_{b}] at this time. The first angle range [θᵢ, θⱼ] is explained below.

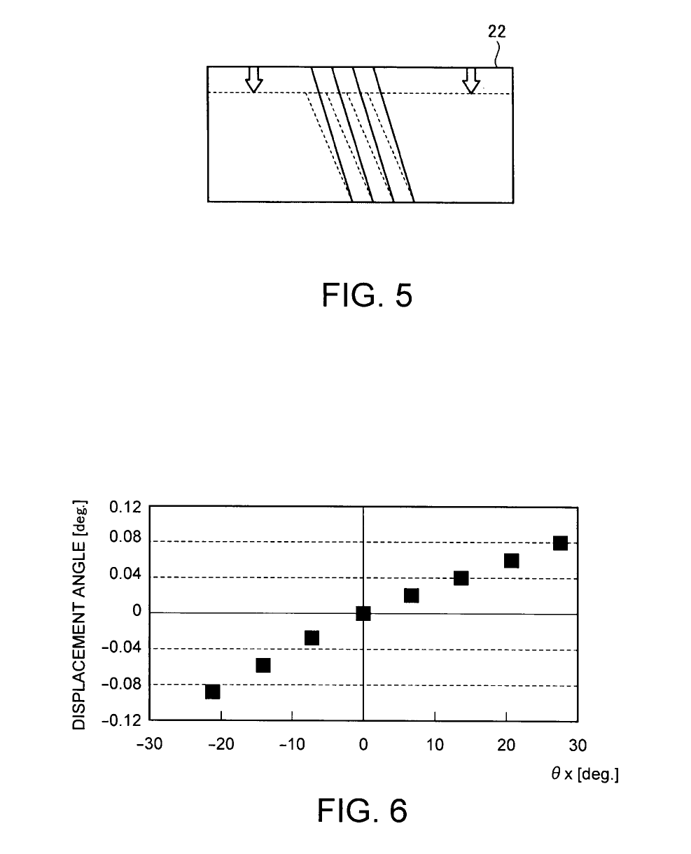

With the advance of the angle-multiplex recording to record information on the recording medium 22, the recording medium 22 undergoes a volumetric shrinkage. The volumetric shrinkage is known to mostly take place in a thickness direction of the recording medium 22. FIG. 5 is a schematic view showing the volumetric shrinkage of the optical information recording medium. As shown in FIG. 5, when the volumetric shrinkage takes place in a thickness direction of the recording medium 22, the angle of the interference fringes recorded in the recording medium 22 changes. Therefore, the incident angle (θ_{R}) of the reference beam 52 at the time of recording information is different from that at the time of reproducing information, thereby making it impossible to precisely read out targeted information.

FIG. 6 is a graph showing a change in a displacement angle at each incident angle of the reference beam 52. The displacement angle means a difference between the incident angles (θ_{R}) of the reference beam at the time of recoding and reproducing. The horizontal axis of the graph in FIG. 6 expresses the recording angle. In addition, the recording angle corresponds to the bisector angle (θₓ), i.e., an angle between the bisector 60 of the intersection angle (θ_{RS}) and the vertical line of the recording medium 22. The intersection angle (θ_{RS}) is defined as an angle between the information beam 50 and the reference beam 52. The vertical axis of the graph in FIG. 6 expresses the displacement angle.

FIG. 6 is a graph showing a relationship between the incident angle of the reference beam and the displacement angle generated at each incident angle thereof. That is, the displacement angles for information recording/reproducing at the respective incident angles were plotted in the graph of FIG. 6. In addition, the displacement angles in the graph of FIG. 6 are confined to the angles for the case of a low energy exposure. The “low energy exposure” means low total energy to expose the recording medium 22, e.g., the comparatively small number of recording times and low beam energy per exposure.

As shown in FIG. 6, the displacement angle is at a minimum at θₓ=0°. As the recording angle (θₓ) deviates from 0° in a plus or minus direction, the displacement angle increases. The volumetric shrinkage less influences the interference fringes near θₓ=0°, whereas the volumetric shrinkage more influences the interference fringes as θₓ deviates from 0°.

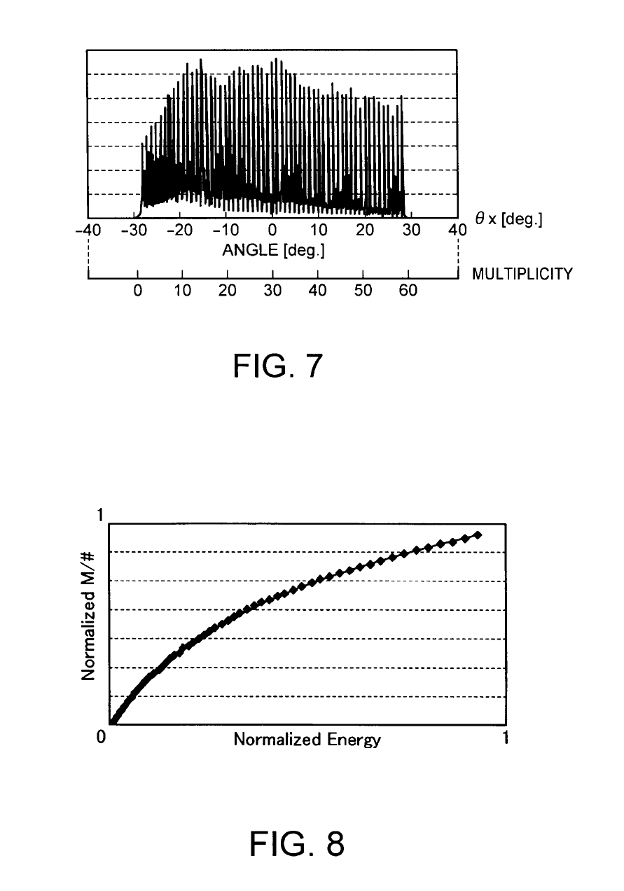

The experiments on the volumetric shrinkage caused by the multiplex recording are shown in FIGS. 7 to 10. The multiplex recording was conducted with information recorded 60 times (60 multiplex) on the same spot of the recording medium 22 while changing the incident angle (θ_{R}) of the reference beam 52 by increments of 1°.

FIG. 7 is a graph showing a diffraction efficiency of beams with which the recording medium 22 is irradiated at each recording angle. The horizontal axis of the graph in FIG. 7 represents the bisector angle (θₓ) as the recording angle, and multiplicity. The multiplicity means the number of the cumulative recording times executed onto the same area of the recording medium 22. The vertical axis of the graph in FIG. 7 represents the diffraction efficiency (η) of beams with which the recording medium 22 is irradiated at each time of recording information. As shown in FIG. 7, the diffraction efficiency increased gradually as the recording angle (θₓ) increases from −30° to −20°. In the range of the recording angle (θₓ) more than −20°, the diffraction efficiency maintains a high value.

FIG. 8 is a graph showing a relationship between an M/# and beam energy given to the recording medium 22. The M/# is a sum of the square roots of the diffraction efficiencies, and is expressed with (formula 2). η is a diffraction efficiency of each incident beam.

M/#=Σ\sqrt{η} (formula 2)

The horizontal axis of the graph in FIG. 8 represents the total energy of the beams with which the same spot of the recording medium 22 is irradiated. The total energy is normalized to 1. The vertical axis of the graph in FIG. 8 represents the M/# normalized to 1. As shown in FIG. 8, more energy is needed to obtain a comparable diffraction efficiency as the number of the recording times executed onto the same spot of the recording medium 22 increases.

As mentioned above, when the multiplicity is small, the energy of the beams accumulated in the recording medium 22 is small. In addition, energy per exposure to be given to the recording medium 22 is small. Therefore, this is a low energy exposure. On the other hand, when the multiplicity is large, the energy of the beams accumulated in the recording medium 22 increases. In addition, energy per exposure to be given to the recording medium 22 is large. This means a high energy exposure.

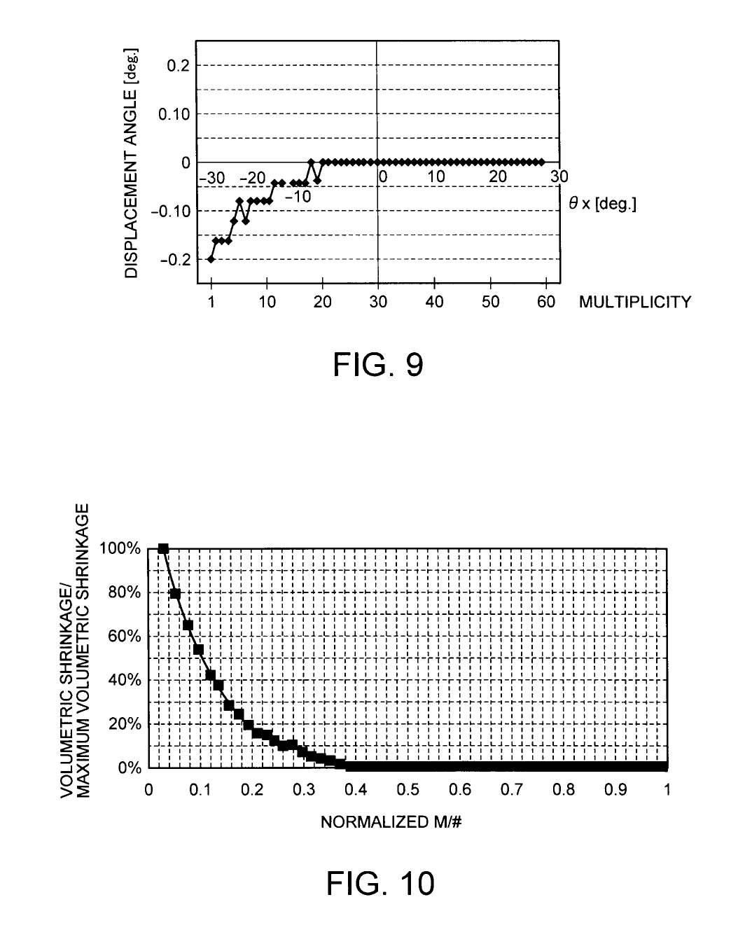

FIG. 9 is a graph showing a relationship between the recording angle (θₓ) and the displacement angle. The horizontal axis of the graph in FIG. 9 represents the recording angle (θₓ) and the multiplicity. The vertical axis of the graph in FIG. 9 represents the displacement angle. As shown in FIG. 9, the angle displacement takes place dominantly below −20°, whereas the angle displacement does not take place at an angle more than −20°.

As shown in FIGS. 7 to 9, just when the recording medium is irradiated with a comparably low energy beam, a total volumetric shrinkage to take place in the recording medium 22 throughout the multiplex recording mostly takes place at once. On the other hand, as shown in FIG. 6, the volumetric shrinkage less influences interference fringes around at the incident angle (θ_{R}) of the reference beam 52 corresponding to θₓ=0°.

The optical information recording/reproducing apparatus 100 according to the first embodiment performs the first to rN-th recording in the first angle range and the (rN+1)-th to N-th recording in the second angle range. N represents the total number of recording times, i.e., the total pages. Here, r is a value in the range of 0<r<1, and represents a rate of the number of recording times in the first angle range to the total number of recording times. The value of r is determined based on the volumetric shrinkage of the recording medium 22. In addition, r is mentioned later again.

The first angle range is an angle range including the incident angle (θ_{R}) fulfilling the bisector angle θₓ=0° of the recordable ranges for the reference beam 52. The second angle range is an angle range of the incident angle (θ_{R}), where the absolute value of the bisector angle θₓ in the second angle range is larger than that in the first angle range, of the recordable ranges of the reference beam 52.

At the start, information is recorded at an incident angle (θ_{R}) of the reference beam 52 at which the absolute value of the bisector angle (θₓ) is comparatively small. This allows it to minimize the displacement angle, even if the volumetric shrinkage takes place in the recording medium 22.

FIG. 10 is a graph showing a volumetric shrinkage due to the information recording on the recording medium 22. The horizontal axis of the graph in FIG. 10 represents an M/# normalized to 1. The vertical axis of FIG. 10 represents a rate of the volumetric shrinkage at each M/# to the maximum volumetric shrinkage. As shown in FIG. 10, 50% of the total change in the volume shrinkage takes place intensively at an M/# of 10%.

Accordingly, the optical information recording/reproducing apparatus 100 according to the first embodiment performs the angle-multiplex recording at an M/# of 10%, where 50% of the maximum volumetric shrinkage takes place, in the first angle range. This means r=0.1. Then, the optical information recording/reproducing apparatus 100 performs the first to 0.1N-th recording in the first angle range, and the (0.1N+1)-th to N-th recording in the second angle range.

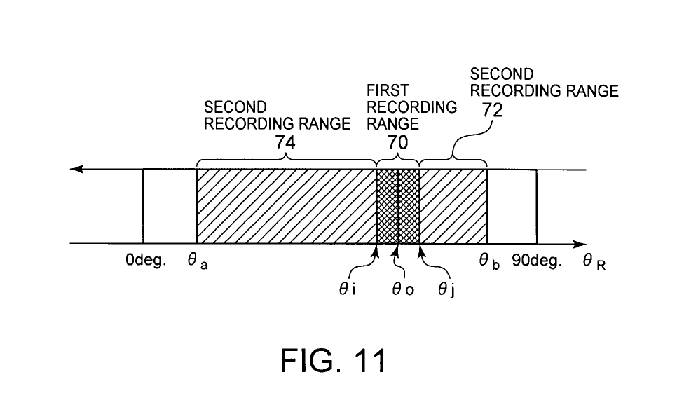

FIG. 11 is a view showing a first angle range and two second angle ranges. As shown in FIG. 11, the first angle range 70 and the second angle ranges 72, 74 are all in the recordable angle range [θₐ, θ_{b}], and in an angle range of the incident angle θ_{R} of the reference beam 52. The first angle range [θᵢ, θⱼ] is the angle range having a rate of r to the recordable range [θₐ, θ_{b}], and is centered at the incident angle θ_{R}=θ₀ for the reference beam 52. Here, θ₀ is the incident angle (θ_{R}) of the reference beam 52 when the bisector angle θₓ=0°.

A more specific recording operation will be explained below. The system controller 31 assigns the first and second angle ranges as a recordable range for the reference beam 52. The first to rN-th recording are performed onto a predetermined spot of the recording medium 22 at an incident angle (θ_{R}) within the first angle range, and followed by the (rN+1)-th to N-th recording onto the predetermined spot of the recording medium 22 at an incident angle (θ_{R}) within the second angle range.

The first angle range [θᵢ, θⱼ] is explained in detail. A recordable angle interval Δθ_{RS} in the above-mentioned (formula 1) is given by (formula 3).

$$Δ {θ}_{RS} ( m ) = \frac{λ}{2 nL sin ( {θ}_{RS} / 2 )} \times m \qquad ( formula 3 )$$

Here, m is a natural number. In addition, the m=1 case and the m=2 case are called a “first null” and a “second null”, respectively. The recording density of first null recording to record information with the first null angle interval is larger than that of second null recording. However, on the other hand, the first null recording has a fault that an SNR falls. Then, in order to obtain a sufficient SNR, the second null is employed. When the second null

$$Δ {θ}_{RS} ( 2 ) = \frac{λ}{2 nL sin ( {θ}_{RS} / 2 )} \times 2 \qquad ( formula 4 )$$

The maximum values θᵢ and θⱼ of the incident angle (θ_{R}) in the first angle range [θᵢ, θⱼ] are given by (formula 5) and (formula 6), respectively.

$$\begin{matrix}\begin{matrix}{θ}_{i} = {θ}_{0} - Δ {θ}_{RS } \times \frac{N}{2} \times r \\ = {θ}_{0} - \frac{λ}{2 nL sin ( {θ}_{RS} / 2 )} \times 2 \times \frac{N}{2} \times 0.1\end{matrix} & ( formula 5 ) \\ \begin{matrix}{θ}_{j} = {θ}_{0} + Δ {θ}_{RS} \times \frac{N}{2} \times r \\ = {θ}_{0} + \frac{λ}{2 nL sin ( {θ}_{RS} / 2 )} \times 2 \times \frac{N}{2} \times 0.1 \end{matrix} & ( formula 6 )\end{matrix}$$

In addition, expressing the angle range with an angle range of the bisector angle (θ_{X}) yields (formula 7).

$$\vert θ \times \vert \leq \frac{λ}{2 nL sin ( {θ}_{RS} / 2 )} \times 2 \times \frac{N}{2} \times r = \frac{λ}{2 nL sin ( {θ}_{RS} / 2 )} \times 2 \times \frac{N}{2} \times 0.1 \qquad ( formula 7 )$$

After the information recording in the first angle range [θᵢ, θⱼ] is completed, the information recording is performed in the second angle range 72, i.e., the angle range [θⱼ+Δθ_{RS}, θ_{b}], and the second angle range 74, i.e., the angle range [θₐ, θᵢ−Δθ_{RS}].

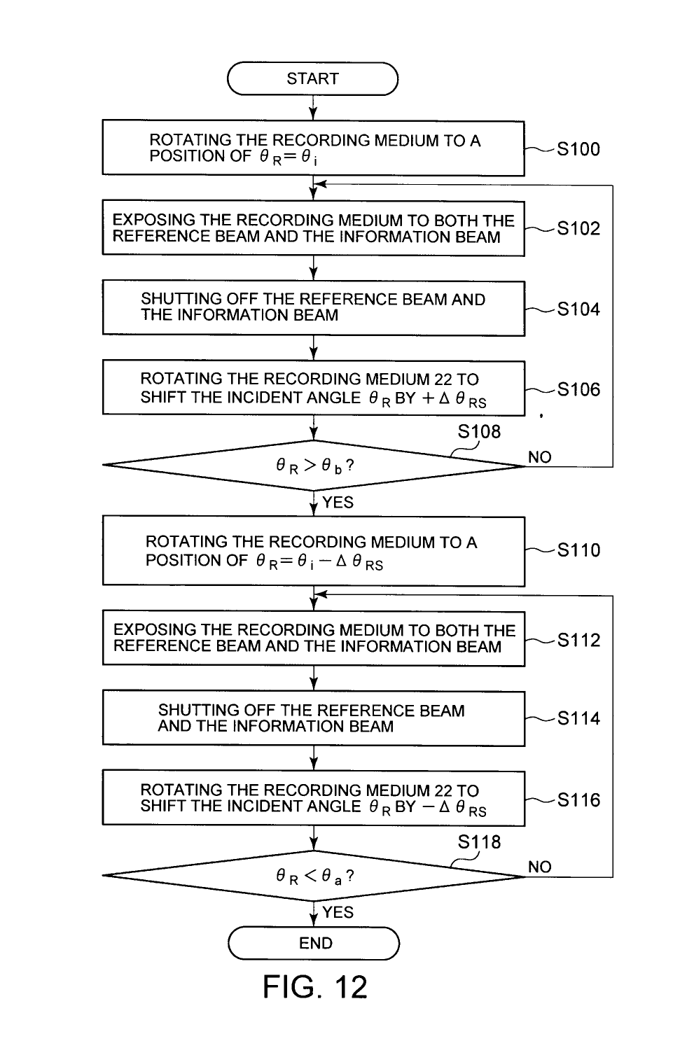

FIG. 12 is a flow chart showing processing of the information recording with the optical information recording/reproducing apparatus 100. Processing of the information recording in the recordable range is explained in detail with reference to FIG. 12. The system controller 31 controls the actuator 30 to rotate the recording medium 22 so that the incident angle θ_{R} of the reference beam 52 is equal to θᵢ. The system controller 31 also controls the light source 10 to emit a beam. That is, the recording medium 22 is irradiated with the reference beam 52 and the information beam 50 simultaneously (Step S102) (exposing the recording medium 22 to both the reference beam 52 and the information beam 50). Thereby, the first recording is performed. The system controller 31 closes the shutters 18 and 20 to shut off the reference beam 52 and the information beam 50 (Step S104).

The system controller 31 controls the actuator 30 to rotate the recording medium 22 so that the incident angle θ_{R} of the reference beam 52 shifts by Δθ_{RS} in a plus direction (Step S106). If the incident angle θ_{R} of the reference beam 52 is θ_{b} or less (“No” at Step S108) at this time, the processing of the information recording returns to (Step 102) to record information again. If the incident angle θ_{R} is larger than θ_{b} at Step 108 (“Yes” at Step 108), the processing of the information recording goes to Step 110.

In accordance with the processing mentioned above, the information recording starts from the minimum θᵢ in the first angle range to increase the incident angle (θ_{R}) by increments of Δθ_{RS} in a plus direction, thereby ending the angle-multiplex recording up to a maximum of θⱼ in the first angle range. Furthermore, increasing the incident angle (θ_{R}) by increments of Δθ_{RS} in a plus direction completes the information recording in the second angle range [θⱼ, θ_{b}] shown in FIG. 11.

The completing of the information recording in the first angle range 72 is followed by (Step S110) where the system controller 31 controls the actuator 30 to rotate the recording medium 22 so that the recording medium rotates to the position of the incident angle θ_{R}=θᵢ−Δθ_{RS} of the reference beam 52 (Step S110). Then, the actuator 30 is controlled so that the recording medium 22 is irradiated with the reference beam 52 and the information beam 50 simultaneously (Step S112) (exposing the recording medium 22 to both the reference beam 52 and the information beam 50). Then, the reference beam 52 and the information beam 50 are shut off (Step S114). The system controller 31 controls the actuator 30 to rotate the recording medium 22 so that the incident angle θ_{R} of the reference beam 52 shifts by Δθ_{RS} in a minus direction (Step S116).

If the incident angle θ_{R} of the reference beam 52 is θₐ or more (“No” at Step S118) at this time, the processing of the information recording returns to (Step S112) to record information again. If the incident angle θ_{R} is smaller than θₐ at Step 108 (“Yes” at Step S108), the processing of the information recording ends. And the angle-multiplex recording is performed on the next book in the same way.

In accordance with the above processing, setting the incident angle θ_{R}=θᵢ−Δθ_{RS} near θ₀ in the second angle range 74 is followed by performing the angle-multiplex recording while changing the incident angle θ_{R} in a direction so as to deviate the incident angle θ_{R} from θ₀, thereby ending the multiplex recording up to Oh of the second angle range 74.

As mentioned above, in the embodiment, performing the multiplex recording in a first recording range is followed by further performing the multiplex recording in a second recording range. In a range where a comparatively large volumetric shrinkage takes place, recording information at the incident angle (θ_{R}) near θ₀ where the volumetric shrinkage less influences the recording/reproduction allows it to perform a stable recording/reproduction of information even if such a large volumetric shrinkage takes place.

In a modified example of this embodiment, the information recording can be performed at small multiplicity in the first angle range earlier than in the second angle range. A recording sequence in the respective angle ranges is not limited in particular. For example, in the first angle range, the incident angle (θ_{R}) can be changed by increments of Δθ_{RS} from θⱼ in a minus direction. Alternatively, the following way of changing the incident angle (θ_{R}) is possible:

the recording medium 22 is firstly rotated so that the incident angle (θ_{R} is set to be θ₀ to start the information recording from θ₀;
secondly the information recording is performed at the incident angle θ_{R}=θ₀+Δθ_{RS}; and
then the information recording is performed at the incident angles θ_{R}=θ₀−Δθ_{RS}, θ₀−2×Δθ_{RS}, and θ₀+2×Δθ_{RS} in sequence.
That is, the information recording may be performed in sequence from the incident angle θ_{R} near θ₀.

As mentioned above, the range of the rate r (=0.1) to the recordable range was set to be as the first recordable range, and all the information recording was performed up to recording times (the number of pages) having a rate of r to the total recording times N in the first angle range. In a second modified example, however, the information recording can be preferentially performed in the first angle range, but all the information recording is not necessarily performed up to the rN-th recording in the first angle range. That is, the absolute value of the bisector angle (θₓ) of the n-th recording (1≦n≦rN) can be smaller than that of the bisector angle (θₓ) in the m-th recording (m>n and rN<m≦N). For example, the information recording can be performed in the first angle range up to recording times of which percentage is 5% of N, and can be further performed in the second angle range more than the recording times. In another example, the information recording can be performed several times of the entire recording times N, of which percentage is 10% of N, in the second angle range.

In a third modified example, the first angle range can cover 20% of the recordable range, and 20% of the total recording times N can be executed in the first angle range. As shown in FIG. 10, just when 20% of the total recording times N is executed, 80% of the maximum volumetric shrinkage has already taken place. Therefore, 20% of the total recording times N is executed in the first angle range to allow it to perform a stable recording/reproduction even if the volumetric shrinkage occurs.

In a fourth modified example, the recordable range may be divided into 3 angle ranges. For example, 10% of the recordable range centered at the incident angle θ_{R}=θ₀ of the reference beam 52, 10% to 20% of the recordable range, and any range other than these two ranges are assigned to a first angle range, a second angle range, and a third angle range, respectively. Then, the information recording is performed in the first, second, and third ranges in this order. When a comparably large volumetric shrinkage takes place, the information recording can be performed at an incident angle (θ_{R}) closer to θ₀, thereby allowing it to perform a stable recording/reproduction even if the volumetric shrinkage occurs.

In a fifth modified example, the angle interval Δθ_{RS} may serve as a first null unit. In this case, Δθ_{RS} is expressed with (formula 8).

$${θ}_{RS} ( 1 ) = \frac{λ}{2 nL sin ( {θ}_{RS} / 2 )} \qquad ( formula 8 )$$

### Second Embodiment

An optical information recording/reproducing apparatus 110 according to a second embodiment changes an incident direction of the reference beam 52 with fixing the recording medium 22, thereby allowing it to change the incident angle (θ_{R}) of the reference beam 52 without rotating the recording medium 22.

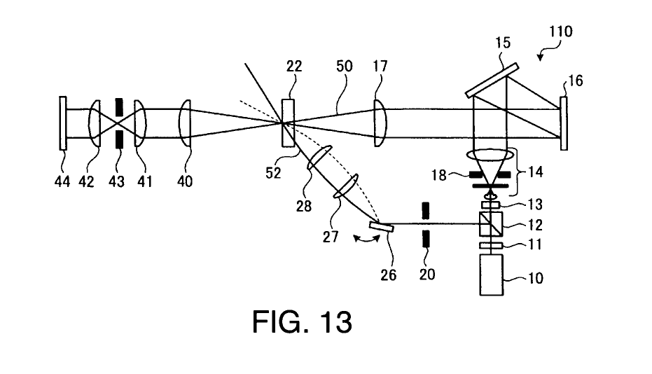

FIG. 13 is a view showing main components of the optical information recording/reproducing apparatus 110 according to the second embodiment. The optical information recording/reproducing apparatus 110 according to the second embodiment includes a galvano-mirror 26 (optical component) instead of the mirror 19. The galvano-mirror 26 rotates so that the incident angle (θ_{R}) of the reference beam 52 to be incident on the recording medium 22 changes. The reference beam 52 is reflected by the galvano-mirror 26, and is allowed to pass through the lenses 27, 28. Then the reference beam 52 is directed to the recording medium 22.

When a direction of the reference beam 52 changes, the intersection angle (θ_{RS}) changes in accordance with the change in the incident angle (θ_{R}) of the reference beam 52. That is, the intersection angle (θ_{RS}) changes for every page. The values of θᵢ, and θⱼ in the first angle range [θᵢ, θⱼ] change for every page, and are expressed with (formula 5) and (formula 6), respectively.

Also in the optical information recording/reproducing apparatus 110 according to the second embodiment, when a comparably large volumetric shrinkage takes place, the information recording can be performed at an incident angle (θ_{R}) closer to θ₀, thereby allowing it to perform a stable recording/reproduction even if the volumetric shrinkage occurs.

In addition, any component and processing of the optical information recording/reproduction apparatus 110 according to the second embodiment other than the galvano-mirror and the processing due to the use of the galvano-mirror described above are the same as those of the optical information recording/reproduction apparatus 100 according to the first embodiment.

The present invention is not limited to the embodiments. Various changes and modifications can be made without departing from the spirit and scope of the present invention, being also incorporated in the present invention. When those skilled in the art can change or modify the embodiments according to the invention, the changed or modified examples can be understood to be incorporated in the scope of the present invention.

What is claimed is:

1. An optical information recording apparatus, comprising:
a spatial beam modulator to convert a light beam emitted from a light source into an information beam carrying information;
an optical component to focus the information beam on an optical information recording medium including an information recording layer in order to irradiate the optical information recording medium with a reference beam and the information beam so that the reference beam and the information beam intersect with each other on the optical information recording layer, the information recording layer being capable of recording information as a hologram with an interference fringe generated by interference between the information beam and the reference beam;
a drive unit to rotate the optical information recording medium or to rotate the optical component; and
a control unit to perform angle-multiplex recording of the information on the optical information recording medium by controlling the light source to emit the light beam while driving the optical information recording medium or the optical component so that an absolute value of a bisector angle θₓ, for n-th recording (1≦n≦rN) is smaller than an absolute value of a bisector angle θₓ for m-th recording (m>n and rN<m≦N), the bisector angle being defined as an angle between a bisector and a vertical line, the bisector being defined as a bisector of an angle θ_{RS} between the information beam and the reference beam, the vertical line being defined as a vertical line of the optical information recording medium,
wherein
N is the number of pages to be defined as the total number of recording times performed on a recording spot of the optical information recording medium;
wherein
the n-th recording and the m-th recording are performed on the recording spot with the reference beam and the information beam; and
wherein
r is a rate to be determined by a volumetric shrinkage of the optical information recording medium, the volumetric shrinkage increasing with irradiating the optical information recording medium with the reference beam and the information beam.

2. The apparatus according to claim 1, wherein the control unit performs the n-th recording in a first angle range, and the m-th recording in a second angle range, the first angle range being expressed in terms of the bisector angle θₓ by the following formula 1, the second angle range having a larger absolute value of the bisector angle θₓ than the first angle range,
wherein
λ is a wavelength of the light beam to be emitted from the light source; and
wherein
L and n are a thickness and a refractive index of the optical information recording medium, respectively.
$$\vert θ \times \vert \leq \frac{λ}{2 nL sin ( {θ}_{RS} / 2 )} \times 2 \times \frac{N}{2} \times r \qquad [ formula 1 ]$$

3. The apparatus according to claim 2,
wherein
the control unit performs the n-th recording with setting the rate (r) to 0.1 in the first angle range expressed by the following formula 2.
$$\vert θ \times \vert \leq \frac{λ}{2 nL sin ( {θ}_{RS} / 2 )} \times 2 \times \frac{N}{2} \times 0.1 \qquad [ formula 2 ]$$

4. A method of optically recording information, comprising:
converting a light beam emitted from a light source into an information beam carrying information by using a spatial beam modulator;
focusing the information beam on an optical information recording medium including an information recording layer in order to irradiate the optical information recording medium with a reference beam and the information beam so that the reference beam and the information beam intersect with each other on the optical information recording layer by using an optical component, the information recording layer being capable of recording information as a hologram with an interference fringe generated by interference between the information beam and the reference beam;
driving to rotate the optical information recording medium or to rotate the optical component by using a drive unit;
controlling the light source to emit the light beam while driving the optical information recording medium or the optical component by using a control unit to perform angle-multiplex recording of the information on the optical information recording medium so that an absolute value of a bisector angle for n-th recording (1≦n≦rN) is smaller than an absolute value of a bisector angle for m-th recording (m>n and rN<m≦N), the bisector angle being defined as an angle between a bisector and a vertical line, the bisector being defined as a bisector of an angle between the information beam and the reference beam, the vertical line being defined as a vertical line of the optical information recording medium,
wherein
N is the number of pages to be defined as the total number of recording times performed on a recording spot of the optical information recording medium;
wherein
the n-th recording and the m-th recording are performed on the recording spot with the reference beam and the information beam; and
wherein
r is a rate to be determined by a volumetric shrinkage of the optical information recording medium, the volumetric shrinkage increasing with irradiating the optical information recording medium with the reference beam and the information beam.
